(19) United States
(12) Patent Application Publication
(10) Pub. No.: US 2010/0015979 A1
(43) Pub. Date: Jan. 21, 2010

(54) Communication Method, Mobile Terminal and Base Station

(75) Inventor: Kenji Kono, Yokohama (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/095,304

(22) PCT Filed: Nov. 22, 2006
(86) PCT No.: PCT/JP2006/323328

§ 371 Date: Sep. 30, 2009

(30) Foreign Application Priority Data
Nov. 28, 2005 (JP) 2005-342175
Nov. 28, 2005 (JP) 2005-342179

(51) Int. Cl. H04W 36/00; H04M 1/00

(52) U.S. Cl. 455/436; 455/561

(57) ABSTRACT

A mobile terminal according to the present invention is provided with: a data communication unit configured to transmit, to a handoff source base station executing data communication, a candidate base station notification notifying a handoff candidate base station having communication capability different from a base station currently executing communication, and to receive, from the handoff source base station, a communication setting change request requesting a change to a handoff destination communication setting corresponding to a communication capability supported by the handoff source base station and all of the handoff candidate base station; and a communication setting execution unit configured to change, on the basis of the communication setting change request, a handoff source communication setting set for the handoff source base station to a communication setting corresponding to the communication setting change request.

### TECHNICAL FIELD

The present invention relates to a communication method, a mobile terminal and a base station, which are used in a mobile communication system including a mixture of devices having different communication capabilities related to data communications.

### BACKGROUND ART

In a mobile communication system using a CDMA (code division multiple access) scheme, multiple schemes with different communication capabilities are adopted as the data communication schemes.

In cdma2000, 1x EV-DO Rev. 0, which achieves a reverse link data rate of 153.6 kbps and a forward link data rate of approximately 2.4 Mbps (hereinafter, abbreviated as “Rev. 0” as appropriate), is specified as the data communication scheme.

Moreover, another specified scheme is 1x EV-DO Rev. A which further increases the data rate of Rev. 0, and achieves a reverse link data rate of approximately 1.8 Mbps and a forward link data rate of approximately 3.1 Mbps (hereinafter, abbreviated as “Rev. A” as appropriate). In comparison with Rev. 0, Rev. A features enhanced QoS control in addition to the aforementioned faster data rates.

In a mobile communication system actually in operation, devices (a base station, a mobile terminal and the like) supporting Rev. A and devices supporting Rev. 0 may coexist.

Thus, such mobile communication system needs to be designed by taking into account how to handle a case where the data communication scheme used in a given device is different from that in a handoff destination.

In this respect, as an example of the handling of such a case, a method of performing handoff while maintaining a PPP session set between a base station and a mobile terminal is disclosed (Japanese Patent Translation Publication No. 2004-515986 (pages 14-16 and FIGS. 5 and 6)).

### DISCLOSURE OF THE INVENTION

Incidentally, changing of contents of a communication setting such as a QoS level during communications is not allowed in Rev. 0.

For this reason, even if a mobile terminal executing data communications in accordance with Rev. A executes handoff to a base station supporting only Rev. 0 while maintaining the PPP session, it is necessary to set the communication setting again with the communications in execution disconnected once. In other words, there is a problem that a duration of communication disconnection in handoff becomes longer.

In this respect, the present invention is made in view of such circumstances. An object of the invention is to provide a communication method, a mobile terminal and a base station that are capable of shortening a duration of communication disconnection in handoff in the presence of a mixture of devices having different communication capabilities related to data communications.

In order to solve the aforementioned problem, the present invention includes the following features. First, a first aspect of the present invention is summarized as a communication method comprising the steps of: transmitting a candidate base station notification notifying a handoff candidate base station having communication capability different from a base station currently executing communication, from a mobile terminal to a handoff source base station currently executing the communication with the mobile terminal; and changing a handoff source communication setting set for the handoff source base station to a communication setting corresponding to the communication capability supported by the handoff source base station and all of the handoff candidate base station on the basis of the candidate base station notification.

A second aspect of the present invention is related to the first aspect of the present invention, and is summarized as the communication method further comprising the step of determining plural pieces of communication setting configuration information indicating a communication setting corresponding to the communication capability, wherein the step of changing changes to the communication setting configuration information supporting the handoff source base station and all of the handoff candidate base station when the candidate base station notification is received.

A third aspect of the present invention is related to one of the first and second aspects of the present invention, and is summarized as the communication method wherein the communication setting configuration information is determined before or at the time when the mobile terminal begins communication with the handoff source base station.

A fourth aspect of the present invention is related to the first to third aspects of the present invention, and is summarized as the communication method further comprising the steps of: rejecting, by the mobile terminal, a change to the communication setting; and rejecting, by the mobile terminal, handoff to the handoff candidate base station when the mobile terminal rejects the change.

A fifth aspect of the present invention is summarized as a mobile terminal (mobile terminal 300) comprising: a candidate base station notification transmitter (data communication unit 321) configured to transmit a candidate base station notification (RouteUpdate message) notifying a handoff candidate base station (base station 200A, for example) having communication capability (QoS level, for example) different from a base station currently executing a communication, to a handoff source base station (base station 100A, for example) currently executing the communication; a request receiver (data communication unit 321) configured to receive a communication setting change request (T-CH Assignment message) requesting a change to a communication setting (Rev. 0, for example) corresponding to communication capability supported by the handoff source base station and all of the handoff candidate base station, from the handoff source base station; and a communication setting execution unit (communication setting execution unit 325) configured to change a handoff source communication setting set for the handoff source base station to a communication setting corresponding to the communication setting change request on the basis of the communication setting change request received by the request receiver.

A sixth aspect of the present invention is related to the fifth aspect of the present invention, and is summarized as the mobile terminal further comprising: a communication setting storage unit (communication setting storage unit 331) configured to store plural pieces of communication setting configuration information (Configuration) indicating a communication setting, corresponding to the communication capability, wherein the communication setting execution unit changes to the communication setting configuration information supporting the handoff source base station and all of the handoff candidate base station on the basis of the communication setting configuration information stored in the communication setting storage unit when the candidate base station notification is received.

A seventh aspect of the present invention is related to one of the fifth and sixth aspects of the present invention, and is summarized as the mobile terminal further comprising: a base station determination unit (handoff determination unit 323) configured to determine whether or not a base station having the communication capability different from the handoff source base station is included in the handoff candidate base station, wherein the communication setting execution unit reverts the communication setting corresponding to the handoff source base station and all of the handoff candidate base station back to the handoff source communication setting when the base station determination unit determines that a base station having the communication capability different from the handoff source base station is not included in the handoff candidate base station.

An eighth aspect of the present invention is summarized as a mobile terminal (mobile terminal 399) comprising: a request receiver (data communication unit 321) configured to receive a communication setting change request requesting a change to a communication setting corresponding to communication capability supported by a: handoff candidate base station having the communication capability different from a base station currently executing communication, from a handoff source base station currently executing communication; a handoff determination unit (handoff determination unit 323) configured to determine whether a change to a communication setting corresponding to the communication setting change request is possible or impossible, on the basis of the communication setting change request received by the request receiver; and a change rejection notification transmitter configured to transmit, to the handoff source base station, a change rejection notification (Attribute Update Reject message) indicating that a change to the communication setting corresponding to the communication setting change request is impossible when the handoff determination unit determines that the change is impossible.

A ninth aspect of the present invention is related to the eighth aspect of the present invention and is summarized as the mobile terminal further comprising a handoff determination unit configured to determine whether a change to a communication setting corresponding to the communication setting change request is possible or impossible, on the basis of the communication setting change request received by the request receiver; and a handoff execution unit configured to exclude the handoff candidate base station from a search target of a handoff destination when the handoff determination unit determines that the change is impossible.

A tenth aspect of the present invention is summarized as a base station (base station 100A, for example) comprising: a candidate base station notification receiver (data communication unit 121) configured to receive a candidate base station notification notifying a handoff candidate base station (base station 200A, for example) having communication capability different from a base station currently executing communication, from a mobile terminal executing the communication; and a communication setting execution unit (communication setting execution unit 125) configured to change a handoff source communication setting set for the mobile terminal to a communication setting corresponding to the communication capability supported by a handoff source base station and all of the handoff candidate base stations on the basis of the candidate base station notification received by the candidate base station notification receiver.

An eleventh aspect of the present invention is related to the tenth aspect of the present invention and is summarized as the base station further comprising a communication setting storage unit (communication setting storage unit 131) configured to store plural pieces of communication setting configuration information indicating a communication setting corresponding to the communication capability, wherein the communication setting execution unit changes to the communication setting configuration information supporting the handoff source base station and all of the handoff candidate base station on the basis of the communication setting configuration information stored in the communication setting storage unit when the candidate base station notification is received.

A twelfth aspect of the present invention is related to one of the tenth and eleventh aspects of the present invention and is summarized as the base station further comprising a base station determination unit (handoff determination unit 123) configured to determine whether or not a base station having different communication capability is included in the handoff candidate base station, wherein the communication setting execution unit reverts the communication setting corresponding to the handoff source base station and all of the handoff candidate base station back to the handoff source communication setting when the base station determination unit determines that a base station having different communication capability is not included in the handoff candidate base station.

A thirteenth aspect of the present invention is related to the tenth to twelfth aspects of the present invention and is summarized as the base station further comprising: a change rejection notification receiver (data communication unit 121) configured to receive a change rejection notification indicating that a change to a communication setting corresponding to the communication capability supported by the handoff candidate base station is impossible, from the mobile terminal; and a handoff rejection unit (handoff execution unit 127) configured to reject handoff of the mobile terminal to the handoff candidate base station when the change rejection notification receiver receives the change rejection notification.

A fourteenth aspect of the present invention is summarized as a communication method comprising the steps of: transmitting a candidate base station notification notifying a handoff candidate base station having communication capability different from a base station currently executing communication, from a mobile terminal: transmitting, from a handoff source base station currently executing the communication with the mobile terminal, communication capability information indicating the communication capability of the handoff candidate base station on the basis of the received candidate base station notification; and changing, by the mobile terminal, a handoff source communication setting set for the handoff source base station to a communication setting corresponding to the communication capability supported by the handoff source base station and all of the handoff candidate base station on the basis of the received communication capability information.

A fifteenth aspect of the present invention is related to the fourteenth aspect of the present invention and is summarized as the communication method further comprising the step of determining plural pieces of communication setting configuration information indicating a communication setting corresponding to the communication capability, wherein in the step of changing changes to the communication setting configuration information corresponding to the handoff candidate base station on the basis of the communication capability information when the mobile terminal executes handoff to the handoff candidate base station.

A sixteenth aspect of the present invention is summarized as a mobile terminal (mobile terminal 300) comprising; a candidate base station notification transmitter (data communication unit 321) configured to transmit a candidate base station notification (Route Update message) notifying a handoff candidate base station (base station 200A, for example) having communication capability (QoS level, for example) different from a base station currently executing communication, to a handoff source base station (base station 100A, for example) currently executing the communications an information receiver (data communication unit 321) configured to receive communication capability information indicating communication capability of the handoff candidate base station, from the handoff source base station; and a communication setting execution unit (communication setting execution unit 325) configured to change a handoff source communication setting set for the handoff source base station to the communication setting corresponding to the handoff source base station and all of the handoff candidate base station, on the basis of the communication capability information received by the information receiver.

A fourth aspect of the present invention is related to the third aspect of the present invention and is summarized as the mobile terminal further comprising: a communication setting storage unit (communication setting storage unit 331) configured to store plural pieces of communication setting configuration information (Configuration) indicating a communication setting corresponding to the communication capability, wherein the communication setting execution unit selects the communication setting configuration information corresponding to the handoff candidate base station from the communication setting storage unit on the basis of the communication capability information, and changes to the selected communication setting configuration information.

A sixth aspect of the present invention is summarized as a base station comprising: a candidate base station notification receiver (data communication unit 121) configured to receive a candidate base station notification notifying a handoff candidate base station (base station 200A, for example) having communication capability different from a base station currently executing communication, from a mobile terminal executing the communication; and an information transmitter (data communication unit 121) configured to transmit communication capability information indicating communication capability of the handoff candidate base station to the mobile terminal on the basis of the candidate base station notification received by the candidate base station notification receiver.

Specifically, according to the features of the present invention, a communication method, a mobile terminal and a base station that are capable of reducing, in a case where a mixture of devices having different communication capabilities for data communications are present, a duration of communication disconnection in handoff can be provided.

### BRIEF DESCRIPTION OF THE DRAWINGS

FIG. 1 is an overall schematic configuration diagram of a mobile communication system according to an embodiment of the present invention.

FIG. 2 is a functional block configuration diagram of a base station according to the embodiment of the present invention.

FIG. 3 is a detailed functional block configuration diagram of a system controller of the base station according to the embodiment of the present invention.

FIG. 4 is a detailed functional block configuration diagram of a system memory of the base station according to the embodiment of the present invention.

FIG. 5 is a functional block configuration diagram of a mobile terminal according to the embodiment of the present invention.

FIG. 6 s a detailed functional block configuration diagram of a system controller of the mobile terminal according to the embodiment of the present invention.

FIG. 7 is a detailed functional block configuration diagram of a system memory of the mobile terminal according to the embodiment of the present invention.

FIG. 8 is a schematic communication sequence diagram related to handoff of the mobile terminal according to the embodiment of the present invention.

FIG. 9 is a detailed operation flow chart (Pattern 1) of the mobile terminal according to the embodiment of the present invention.

FIG. 10 is a detailed operation flow chart (Pattern 1) of the base station according to the embodiment of the present invention.

FIG. 11 is a detailed operation flow chart (Pattern 2) of the mobile terminal according to the embodiment of the present invention.

FIG. 12 is a detailed operation flow chart (Pattern 2) of the base station according to the embodiment of the present invention.

FIGS. 13 are (partial) operation flow charts of a mobile terminal and a base station according to a modification example of the present invention.

FIG. 14 is a schematic communication sequence diagram related to handoff of a mobile terminal according to the modification example of the present invention.

FIG. 15 is a detailed operation flow chart of the mobile terminal according to the modification example of the present invention.

### BEST MODE FOR CARRYING OUT THE INVENTION

Next, an embodiment of the present invention will be described. Note that same or similar reference numerals are given to denote same or similar portions in the descriptions of the drawings, hereinafter. The drawings are only schematically shown, and proportions of sizes and the like are different from actual ones, however.

Accordingly, the specific sizes and the like should be judged by referring to the description below. Furthermore, as a matter of course, there are included portions where relationships or proportions of sizes of the drawings are different with respect to one another.

(Overall Schematic Configuration of Mobile Communication System)

Next, an embodiment of the present invention will be described. Note that same or similar reference numerals are given to denote same or similar portions in the descriptions of the drawings, hereinafter. The drawings are only schematically shown, and proportions of sizes and the like are different from actual ones, however.

Accordingly, the specific sizes and the like should be judged by referring to the description below. Furthermore, as a matter of course, there are included portions where relationships or proportions of sizes are different from one diagram to another.

(Overall Schematic Configuration of Mobile Communication System)

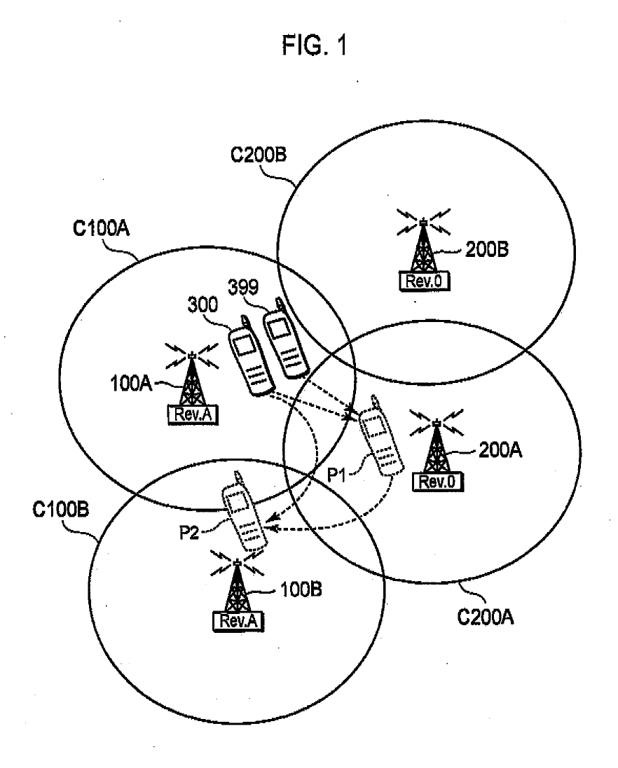

FIG. 1 is an overall schematic configuration diagram of a mobile communication system according to the present embodiment. As shown in FIG. 1, a mobile communication system 10 is configured of a plurality of base stations (base stations 100A, 100B, 200A and 200B) and a plurality of mobile terminals (mobile terminals 300 and 399). Note that the numbers of base stations and mobile terminals constituting the mobile communication system 10 are not limited to the numbers shown in FIG. 1.

The mobile communication system 10 is a mobile communication system in accordance with a CDMA2000 scheme, and employs multiple schemes having different communication capabilities as the data communication schemes.

Specifically, 1x EV-DO Rev. 0 (Rev. 0 ) and 1x EV-DO Rev. A (Rev. A) are employed, which respectively achieve data rates so of 153.6 kbps for reverse link and of approximately 2.4 Mbps for forward link, and data rates approximately 1.8 Mbps for reverse link and of approximately 3.1 Mbps for forward link. In comparison with Rev. 0. Rev. A features enhanced QoS control in addition to the aforementioned faster data rates.

The base stations 100A and 100B are base stations supporting Rev. 0 and Rev. A. The base stations 100A and 100B respectively form cells C100A and C100B. the base stations 200A and 2003 are base stations supporting only Rev. 0. The base stations 200A and 200B respectively form cells C200A and C200B.

The mobile terminal 300 is a mobile terminal supporting Rev. 0 and Rev. A. The mobile terminal 300 is capable of executing communications (data communications) with the base stations 100A and 100B and the base stations 200R and 200B.

The mobile terminal 399 is a mobile terminal supporting only Rev. A. The mobile terminal 399 is capable of executing communications (data communications) with the base stations 100A and 100B, but is not capable of communicating with the base stations 200A and 200B.

(Functional Block Configuration of Mobile Communication System)

Next, a description will be given of a functional block configuration of the base station 100A the mobile terminal 300 and the mobile terminal 399, which constitute the mobile communication system 10.

Note that hereinafter, the description will be mainly given of portions related to the present invention. It should be noted that there is thus a case where the base station 100A, the mobile terminal 300 and the mobile terminal 399 include an logical block (such as a power supply unit) essentially required to implement the functions as the device, but not illustrated or whose description is omitted herein.

### (1) Base Station

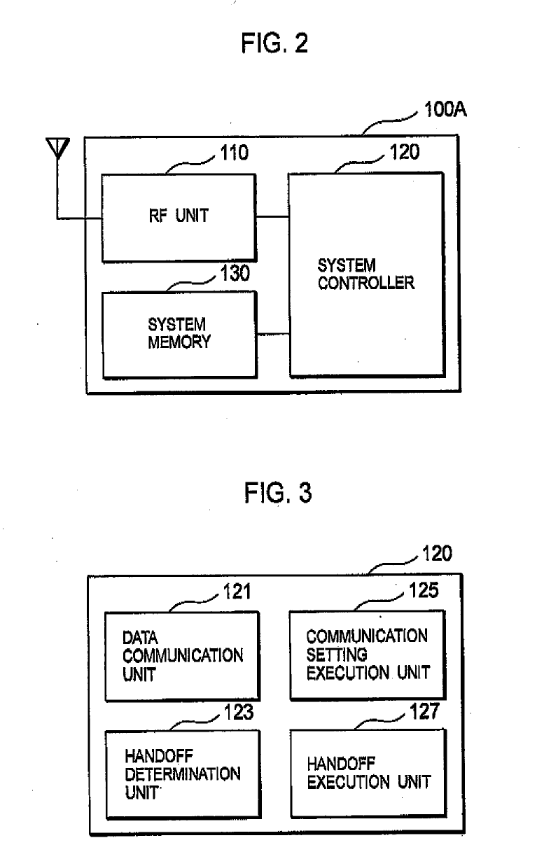

FIG. 2 is a functional block configuration diagram of the base station 100A. Note that the base stations 100A and 100B include the same functional block configuration.

As shown in FIG. 2, the base station 100A is provided with an RF unit 110, a system controller 120 and a system memory 130.

The RF unit 110 transmits and receives a radio signal in accordance with CDMA between the mobile terminals 300 and 399. Moreover, the RF unit 110 executes conversion of the radio signal into a baseband signal and transmits and receives the baseband signal to and from the system controller 120.

The system controller 120 controls various types of functions included in the base station 100A. A description of more detailed functional blocks of the system controller 120 related to the present embodiment will be given later.

The system memory 130 stores, therein, various types of information used in a control or the like performed in the base station 100A. A description of more detailed functional blocks of the system memory 130 related to the present embodiment will be given later.

Note that the base stations 200A and 200B supporting only Rev. 0 also include substantially the same functional block configuration as that of the base station 100A shown in FIG. 2. Moreover, a detailed description of each functional block constituting the base stations 200A and 200B is omitted here.

(1.1) System Controller 120

FIG. 3 is a detailed functional block configuration diagram of the system controller 120. As shown in FIG. 3, the system controller 120 is provided with a data communication unit 121, a handoff determination unit 123, a communication setting execution unit 125 and a handoff execution unit 127.

The data communication unit 121 executes processing related to data communications for image contents, music contents or the like, and transmission and receipt of various types of control information (a RouteUpdate message and T-CH Assignment message, for example).

As described above, the base station 100A is abase station supporting Rev. 0 and Rev, A and is thus capable of executing data communications with data rate of reverse link: approximately 1.8 Mbps and of forward link: approximately 3.10 Mbps.

Moreover, in this embodiment, particularly, the data communication unit 121 receives, from the mobile terminal (the mobile terminal 300, for example) currently executing relevant data communication, a RouteUpdate message (candidate base station notification) for setting base stations to be handoff candidate base stations including a base station having a different communication capability related to data communications (a QoS level or data rate, for example) from that of the base station currently executing the data communications. In the present embodiment, the data communication unit 121 constitutes a candidate base station notification receiver.

Furthermore, the data communication unit 121 is capable of receiving, from the mobile terminal 399, a change rejection notification indicating that a change to a communication setting corresponding to a communication capability supported by all of the handoff candidate base stations cannot be performed. In this embodiment, the data communication unit 121 constitutes a change rejection notification receiver.

For example, from the mobile terminal 399 supporting only Rev. A, the data communication unit 121 is capable of receiving a change rejection notification indicating that the mobile terminal 399 cannot make a change to a communication setting corresponding to the communication capabilities of the base stations 200A and 200B supporting only Rev. 0.

In addition, on the basis of a RouteUpdate message (candidate base station notification) for setting, as a handoff candidate base station, a base station having a different communication capability related to the received data communication currently in execution, the data communication unit 121 is capable of transmitting a RevInformation message (communication capability information) to the mobile terminal, the message indicating the communication capability of a handoff candidate base station. In this embodiment, the data communication unit 121 constitutes an information transmitter.

The handoff determination unit 123 determines, on the bases of the state of a radio signal transmitted from or received by the RF unit 110, or the like, whether or not to execute handoff of a mobile terminal executing communications with the base station 100A. Particularly, in the present embodiment, the handoff determination unit 123 is capable of determining whether or not a base station having a different communication capability (the base station 200A, for example) is included in the handoff candidate base stations. In this embodiment, the handoff determination unit 123 constitutes a base station determination unit.

The communication setting execution unit 125 executes communication settings including a QoS level, a data rate, various types of protocols and the like, which are executed between the mobile terminal 300 and the mobile terminal 399.

Particularly, in this embodiment, the communication setting execution unit 125 changes, on the basis of the RouteUpdate message received by the data communication unit 121, communication settings (handoff source communication settings) set between itself and a mobile terminal (the mobile terminal 300, for example) to communication settings (communication settings) corresponding to a communication capability supported by the base station (handoff source base station) currently in communications and all of the handoff candidate base stations.

For example, in a case where it is notified from the mobile terminal 300 that the base stations 200A and 200B supporting only Rev. 0 are to be the handoff candidate base stations, the communication setting execution unit 125 determines a protocol or a data rate in accordance with Rev. 0, which is at the lowest level, as the contents of the communication settings corresponding to the communication capability supported by all of the handoff candidate base stations. Note that since Rev. A is an enhanced version of the communication scheme of Rev. 0, Rev. A includes the communication capability of Rev. 0, so that the communication setting can be changed.

More specifically, in a case where a RouteUpdate message (candidate base station notification) including handoff candidate base stations is received, the RouteUpdate message is stored in the system memory 130 (specifically, a communication setting storage unit 131 to be described later), and the communication setting execution unit 125 changes, on the basis of configuration (communication setting configuration information) indicating the contents of communication settings, the configuration to a configuration taking the handoff candidate base stations into consideration. Note that the configuration includes QoS control, data rates, an assignment of stream (stream protocol/virtual stream protocol) used in and data communications, and the like.

Moreover, in a case where it is determined by the handoff determination unit 123 that a base station having a different communication capability is no longer included in the handoff candidate base stations, the communication setting execution unit 125 can change the communication settings back to communication settings (handoff source communication settings) corresponding to the communication capability supported by the base station 100A again as the communication settings corresponding to the communication capability supporting the base station currently in communications and all of the handoff candidate base stations.

The handoff execution unit 127 executes handoff of the mobile terminal. 300 and the mobile terminal 399. In addition, in this embodiment, in a case where the data communication unit 121 receives a change rejection notification, the handoff execution unit 127 is capable of rejecting handoff of the mobile terminal (the mobile terminal 399, for example) to the handoff candidate base station (the base station 200A, for example). In this embodiment, the handoff execution unit 127 constitutes a handoff rejection unit.

(1.2) System Memory 130

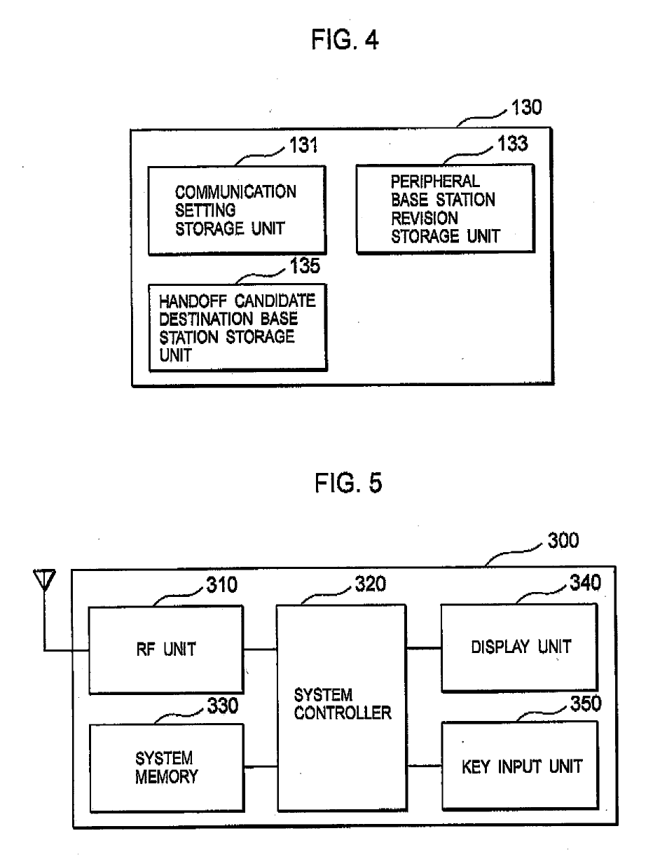

FIG. 4 is a detailed functional block configuration diagram of the system memory 130. As shown in FIG. 3, the system memory 130 is provided with a communication setting storage unit 131, a peripheral base station Revision storage unit 133 and a handoff candidate destination base station storage unit 135.

The communication setting storage unit 131 stores, therein, a plurality of configurations indicating a communication settings corresponding to communication capabilities. In this embodiment, the communication setting storage unit 131 stores configurations corresponding to Rev. 0 and Rev. A. Moreover, the communication settings include QoS control, a data rate, an assignment of stream (steam protocol/virtual stream protocol) used in data communications, and the like.

The peripheral base station Revision storage unit 133 stores, therein, Revision (Rev. 0 or Rev. A) supported by the base stations 100B, 100B, 200A and 200B, which are arranged at a periphery of the base station 100A.

The handoff candidate destination base station storage unit 135 stores, therein, a handoff candidate base station included in a RouteUpdate message received by the data communication unit 121.

### (2) Mobile Terminal (Mobile Terminal 300)

FIG. 5 is a functional block configuration diagram of the mobile terminal 300. Note that a description of a block providing the same function as that provided by a functional block included in the aforementioned base station 100A is omitted when appropriate.

As shown in FIG. 5, the mobile terminal 300 includes an RF unit 310, a system controller 320, a system memory 330, a display unit 340 and a key input unit 350.

The RF unit 310, the system controller 320 and the system memory 330 respectively correspond to the RF unit 110, the system controller 120 and the system storage unit 130 of the base station 100A. The RF unit 310, the system controller 320 and the system memory 330 provide the same functions as those of the RF unit 110, the system controller 120 and the system storage unit 130 of the base station 100A, respectively.

The display unit 340 displays image contents or the like received via the RF unit 310 and the system controller 320, or displays operation contents (an input phone number, address or the like).

The key input unit 350 is configured of a ten key, function keys, or the like and is an interface used for receiving operation contents of the user.

(2.1) System Controller 320

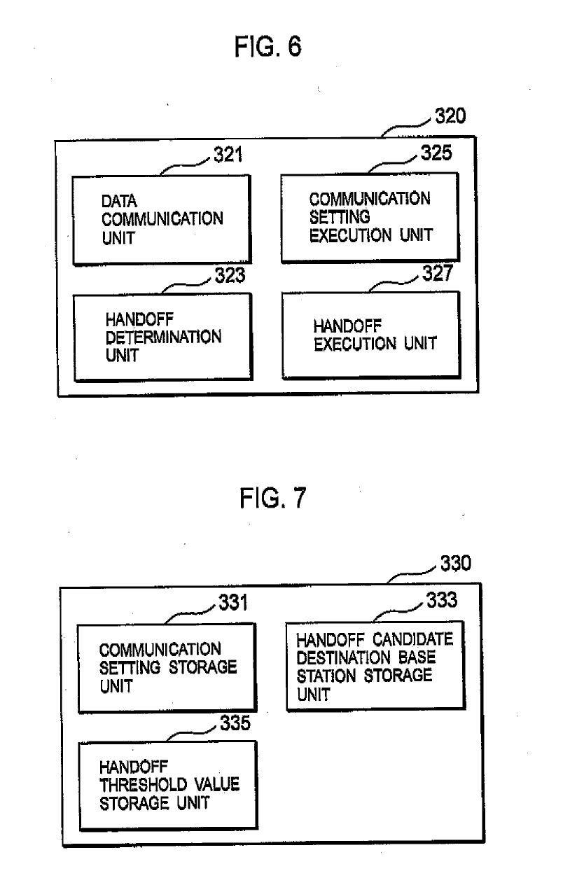

FIG. 6 is a detailed functional block configuration diagram of the system controller 320. As shown in FIG. 6, the system controller 320 is provided with a data communication unit 321, a handoff determination unit 323, a communication setting execution unit 325 and a handoff execution 327.

The data communication unit 321 transmits, to the handoff source base station (the base station 100A, for example) executing the data communications, a RouteUpdate message (candidate base station notification) for setting handoff candidate base stations (the base station 200A, for example) including a base station having a different communication capability related to data communication from that of the data communications currently in execution. In this embodiment, the data communication unit 321 constitutes a candidate base station notification transmitter.

In addition, the data communication unit 321 receives, from the handoff source base station, a communication setting change request for requesting a change to a communication setting corresponding to a communication capability supported by all of the handoff candidate base stations including the base station (handoff source base station) currently in communications. In this embodiment, the data communication unit 321 constitutes a request receiver.

Moreover, the data communication unit 321 is capable of receiving, from the handoff source base station, a RevInformation message (communication capability information) indicating a communication capability of a handoff candidate base station. In this embodiment, the data communication unit 121 constitutes an information receiver.

The handoff determination unit 323 is capable of determining whether or not a base station having a communication capability different from that of the handoff source base station is included in the handoff candidate base stations. In this embodiment, the handoff determination unit 323 constitutes a base station determination unit.

The communication setting execution unit 325 changes, on the basis of a T-CH Assignment message received by the data communication unit 321, communication settings (handoff source communication settings) set between itself and the handoff source base station to a communication setting taking the handoff candidate base stations into consideration.

Specifically, in a case where the T-CH Assignment message is received, the communication setting execution unit 325 changes, on the basis of the configurations stored in the system memory 330 (specifically, the communication setting storage unit 331), the configuration to a configuration determined by taking the handoff candidate base stations into consideration.

Moreover, in a case where it is determined by the handoff determination unit 323 that the base station having a different communication capability from that of the handoff source base station is no longer included in the handoff candidate base stations, the communication setting execution unit 325 is capable of changing the communication settings back to the handoff source communication settings since the handoff candidate base stations are the ones having the same communication capability as that of the handoff source base station.

Furthermore, the communication setting execution unit 325 is capable of changing, on the basis of the RevInformation message received by the data communication unit 321, the communication settings to communication settings corresponding to a communication capability supported by all of the handoff candidate base stations.

The handoff execution unit 327 executes handoffs with the base stations (the base stations 100A, 100B, 200A and 200B)

(2.2) System Memory 330

FIG. 7 is a detailed functional block configuration diagram of the system memory 330. As shown in FIG. 3, the system memory 330 is provided with a communication setting storage unit 331, a handoff candidate destination base station storage unit 333 and a handoff threshold value storage unit 335.

The communication setting storage unit 331 stores, therein, a plurality of configurations showing communication settings corresponding to communication capabilities.

The handoff candidate destination base station storage unit 333 stores, therein, a handoff candidate base station included in the T-CH Assignment message received by the data communication unit 321.

The handoff threshold value storage unit 335 stores a handoff threshold value (for example, a threshold value of pilot signal strength) for determining whether or not to perform handoff to a handoff candidate base station.

### (3) Mobile Terminal (Mobile Terminal 399)

The mobile terminal 399 includes the same functional block configuration as that of the aforementioned mobile terminal 300 (FIGS. 5 to 7). However, since the mobile terminal 399 is a mobile terminal supporting only Rev. A, some parts of the functions thereof are different from those of the mobile terminal 300. Hereinafter, a description will be mainly given of the parts of the functions of the mobile terminal 399, which are different from those of the mobile terminal 300.

In the case of the mobile terminal 399, in a case where the handoff determination unit 323 determines that a change to the communication settings (specifically, Rev. 0) of the handoff destination cannot be made, the data communication unit 321 can transmit, to the handoff source base station (for example, the base station 100A), an Attribute Update Reject message (change rejection notification) indicating that the change to the communication settings cannot be made. In this embodiment, the data communication unit 321 constitutes a change rejection notification transmitter.

Furthermore, in the case of the mobile terminal 399, the handoff determination unit 323 can determine, on the basis of the communication setting change request received by the data communication unit 321, whether or not a change to the communication settings of the handoff destination can be made.

In this embodiment, the handoff determination unit 323 constitutes a handoff determination unit.

Furthermore, in the case of the mobile terminal 399, the handoff execution unit 327 can exclude the handoff candidate base station (for example, the base station 200A) from handoff destination search targets in a case where it is determined by the handoff determination unit 323 that the change to the communication settings of the handoff destination cannot be made.

(Operation of Mobile Communication System)

Next, a description will be given of an operation of the aforementioned mobile communication system 10. Specifically, is a description will be given of an operation in which handoff of the mobile terminal 300 is performed from the base station 100A supporting Rev. 0 and Rev. A to the base station 200A supporting only Rev. 0.

### (1) Schematic Communication Sequence

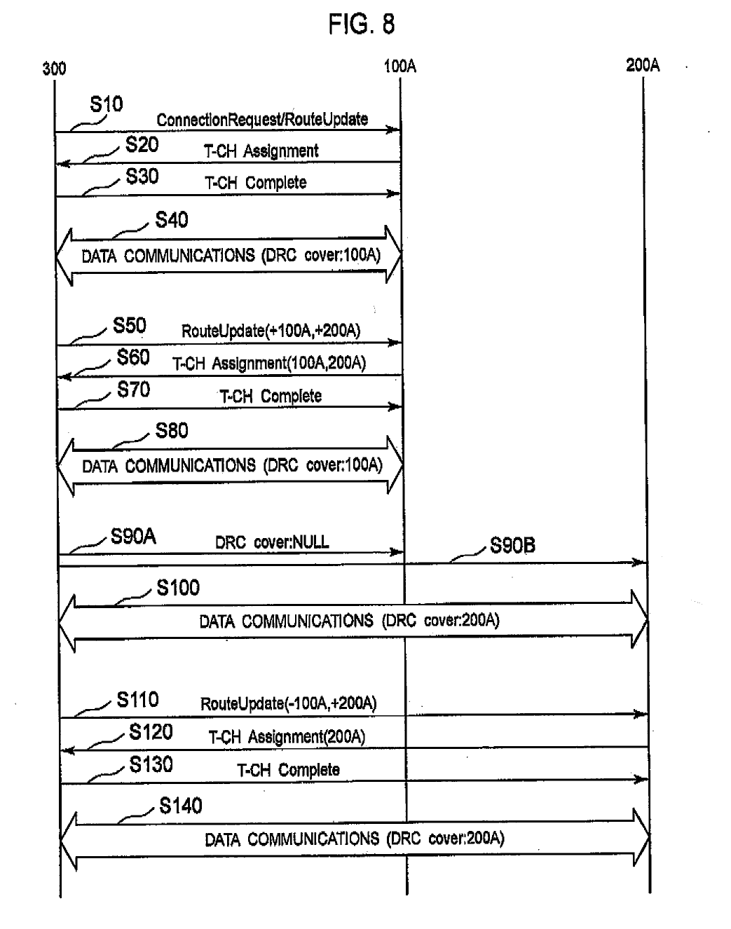

FIG. 8 is a schematic communication sequence diagram related to handoff of the mobile terminal 300 from the base station 100A to the base station 200A. As shown in FIG. 8, in step 51, the mobile terminal 300 transmits a ConnectionRequest message for requesting a connection to the base station 100A and a RouteUpdate message including a base station that is to be a candidate of the handoff destination of the mobile terminal 300.

In step S20, the base station 100A transmits, to the mobile terminal 300, a T-CH Assignment message allowing data communications with the base station 100A.

In step S30, on the basis of the received T-CH Assignment message, the mobile terminal 300 executes connection processing for connecting to the base station 100A (for example, assignment of T-CH), and then transmits a T-CH Complete message to the base station 100A.

In step S40, the base station 100A and the mobile terminal 300 execute the communication settings in accordance with Rev. A, and then begin data communications. Specifically, the communication settings are executed in accordance with the configuration of Rev. A stored in the communication setting storage unit (the communication setting storage unit 131 and the communication setting storage unit 331).

Here, an assumption is made that the mobile terminal 300 moves towards a position P₁ shown in FIG. 1 after the data communications begin. If the mobile terminal 300 moves towards the position P₁, the value of the pilot signal strength of the base station 200A increases in the mobile terminal 300.

In step S50, the mobile terminal 300 transmits, to the base station 100A, a RouteUpdate message indicating that the pilot signal strength of the base station 200A has become equal to or greater than a predetermined threshold value (threshold value α).

In step S60, the base station 100A determines, on the basis of the received RouteUpdate message, whether or not the base station 200A can communicate. Moreover, the base station 100A transmits, to the mobile terminal 300, a T-CH Assignment message indicating that handoff to the base station 200A can be performed.

In step S70, on the basis of the received T-CH Assignment message, the mobile terminal 300 executes processing for setting the base station 200A to be the handoff candidate base station, and then transmits, to the base station 100A, a T-CH Complete message indicating that the processing is completed,

In step S80, the base station 100A and the mobile terminal 300 change the configuration of Rev. A to the configuration of Rev. 0, in a state that the data communications between them are maintained. Specifically, the base station 100A and the mobile terminal 300 recognize that handoff of the mobile terminal 300 to the base station 200A supporting only Rev. 0 may be performed, and thus change the configuration to the configuration of Rev. 0.

Here, an assumption is made that the mobile terminal 300 further moves towards the position P₁ shown in FIG. 1.

In step S90A, on the basis of the fact that the pilot signal strength of the base station 200A has become greater than the pilot signal strength of the base station 100A, the mobile terminal 300 transmits, to the base station 100A, DRC cover:NULL indicating that the handoff to the base station 200A is performed. Moreover, in step S90B, the mobile terminal 300 transmits DRC cover:NULL to the base station 200A as in the case of the base station 100A.

In step S100, the base station 200A and the mobile terminal 300 begin data communications based on the communication settings in accordance with Rev. 0. Here, an assumption is made that the mobile terminal 300 further moves towards the position P₁ shown in FIG. 1.

In step S110, the mobile terminal 300 transmits, to the base station 200A, a RouteUpdate message indicating that the pilot signal strength transmitted from the base station 100A has become lower than a predetermined threshold value.

In step S120, on the basis of the received RouteUpdate message, the base station 200A transmits, to the mobile terminal 300, a T-CH Assignment message instructing the mobile terminal 300 to exclude the mobile terminal 100A from handoff candidate base stations.

In step S130, on the basis of the received T-CH Assignment message, the mobile terminal 300 executes processing for excluding the base station 100A from the handoff candidate base stations, and then transmits, to the base station 200A, a T-CH Complete message indicating that the processing is completed.

In step S140, the base station 200A and the mobile terminal 300 continue data communications in accordance with Rev. 0.

### (2) Detailed Operation Flow

Next, a description will be given of a detailed operation flow of the base station 100A and the mobile terminal 300, which execute the aforementioned communication sequence. Here, two types of operation flows (Patterns 1 and 2) will be described.

### (2.1) Pattern 1

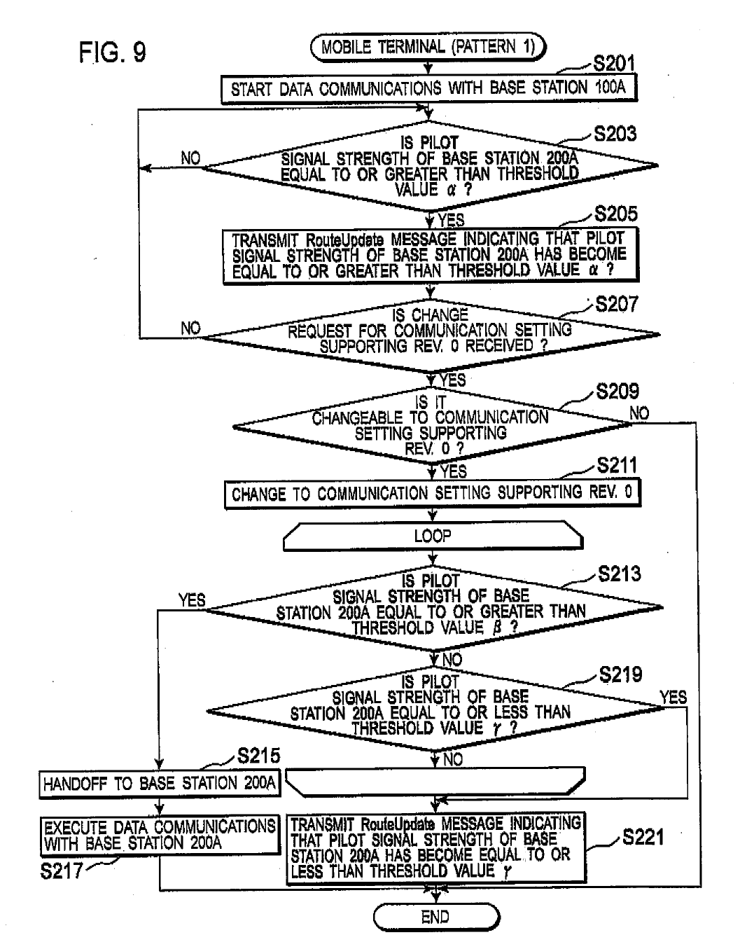

FIG. 9 is a detailed operation flow chart of the mobile terminal 300 according to Pattern 1. As shown in FIG. 9, in step S201, the mobile terminal 300 begins data communications is with the base station 100A.

In step S203, the mobile terminal 300 determines whether or not the pilot signal strength of the base station 200A is equal to or greater than a threshold value α.

In a case where the pilot signal strength of the base station 200A is equal to or greater than the threshold value α (YES in step S203), in step 8205, the mobile terminal 300 transmits, to the base station 100A, a RouteUpdate message as indicating that the pilot signal strength of the base station 200A has become equal to or greater than the predetermined threshold value.

Upon receipt of a request for a change to the communication setting supporting Rev. 0 (communication setting change request) in step S207, the mobile terminal 300 determines whether or not the change to the communication setting supporting Rev. 0 can be made in step S209.

In a case where the change to the communication setting supporting Rev. 0 can be made (YES in step S209), the mobile terminal 300 performs a change to the communication setting supporting Rev. 0 in step S211.

Specifically, the mobile terminal 300 determines a configuration supporting Rev. 0 between itself and the base station 100A, and performs a change to the communication setting in accordance with the configuration.

In step S213, the mobile terminal 300 determines whether or not the pilot signal strength of the base station 200A is equal to or greater than a threshold value β.

In a case where the pilot signal strength of the base station 200A is equal to or greater than the threshold value β (YES in step S213), the mobile terminal 300 executes handoff to the base station 200A in step S215.

In step S217, the mobile terminal 300 executes data communications with the base station 200A based on the communication setting in accordance with Rev. 0.

In a case where the pilot signal strength of the base station 200A is not greater than the threshold value β (NO in step S213), the mobile terminal 300 determines whether or not the pilot signal strength of the base station 200A is equal to or less than a threshold value γ in step S219.

In a case where the pilot signal strength of the base station 200A is equal to or less than the threshold value γ (YES in step S219), in step S221, the mobile terminal 300 transmits, to the base station 100A, a RouteUpdate message indicating that the pilot signal strength of the base station 200A has become equal to or less than the threshold value γ.

Note that an example of a case where the pilot signal strength of the base station 200A becomes equal to or less than the threshold value γ after becoming the threshold value α is a case where the mobile terminal 300 moves towards a position P₂ after moving towards near the base station 200A once as shown by a dotted line in FIG. 1.

In a case where the pilot signal strength of the base station 200A is greater than the threshold value γ (NO in step S219), the mobile terminal 300 repeats the processing starting from step S213.

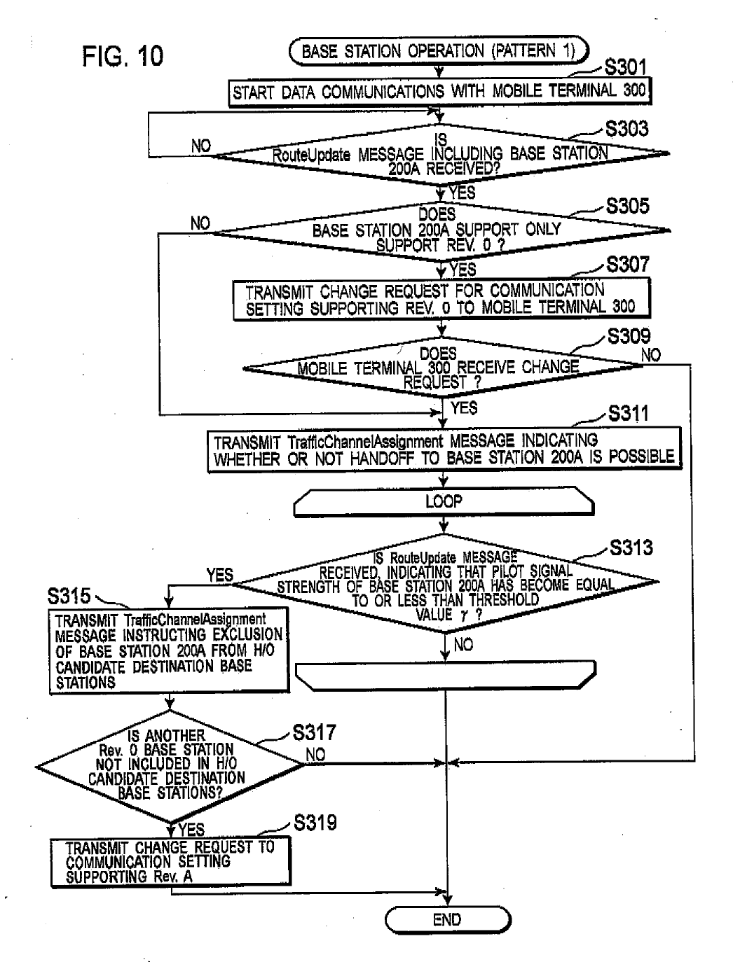

FIG. 10 is a detailed operation flow chart of the base station 100A according to Pattern 1 As shown in FIG. 10, in step S301, the base station 100A begins data communications with the mobile terminal 300.

In step S303, the base station 100A determines whether or not a RouteUpdate message including the base station 200A, that is, a RouteUpdate message indicating that the pilot signal strength of the base station 200A has become equal to or greater than the threshold value α is received.

In a case where the RouteUpdate message including the base station 200A is received (YES in step S303), the base station 100A determines whether or not the base station 200A supports only Rev. 0 in step S305.

In a case where the base station 200A supports only Rev. 0 (YES in step S305), in step S307, the base station 100A transmits, to the mobile terminal 300, a request for a change to communication settings supporting Rev. 0 (communication setting change request).

In a case where the base station 200A supports not only Rev. 0 but also Rev. A (NO in step $305), the base station 100A executes the processing in step S311.

In step S309, the base station 100A determines whether or not the mobile terminal 300 receives a request for a change to communication settings supporting Rev. 0. Specifically, the base station 100A determines whether or not a message corresponding to the request for a change (for example an Attribute Update Accept message) is received from the mobile terminal 300, and thereby determines whether or not the request for a change is received.

In a case where the mobile terminal 300 receives a request for a change to communication settings supporting Rev. 0 (YES in step S309), in step 8311, the base station 100A transmits, to the mobile terminal 300, a T-CH Assignment message indicating that handoff to the base station 200A can be performed.

In a case where the mobile terminal 300 does not receive a request for a change to communication settings supporting Rev. 0 (NO in step S309), the base station 100A ends the processing without transmitting a T-CH Assignment message.

In step 6313, the base station 100A determines whether or not a RouteUpdate message indicating that the pilot signal strength of the base station 200A has become equal to or less than the threshold value γ is received from the base station 100A.

In a case where the RouteUpdate message is received (YES in step S313), in step S315, the base station 100A transmits, to the mobile terminal 300, a T-CH Assignment message instructing the mobile terminal 300 to exclude the base station 200A from handoff candidate base stations (H/O destination candidate base stations).

In step S317, the base station 100A determines whether or not another base station (the base station 200B) supporting only Rev. 0 is included in the handoff candidate base stations.

When another base station supporting only Rev. 0 is not included (YES in step S317), the base station 100A transmits a request for a change to communication settings supporting Rev. A to the mobile terminal 300 in step S319.

In a case where another base station supporting only Rev. 0 is included (NO in step S317), the base station 100A ends the processing.

### (3) Pattern 2

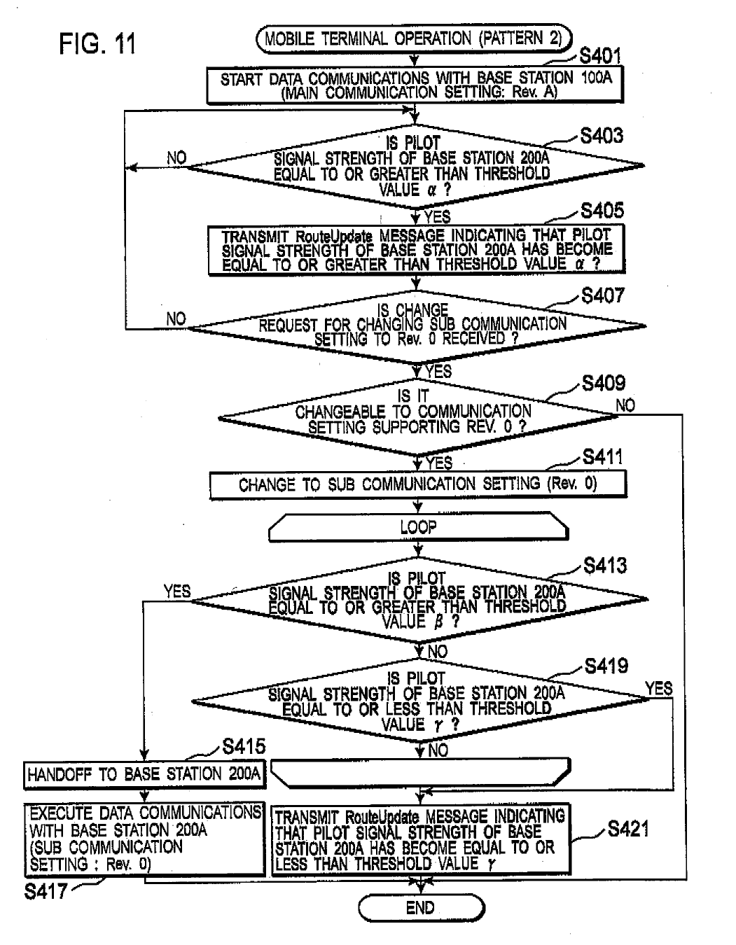

FIG. 11 is a detailed operation flow chart of the mobile terminal 300 according to Pattern 2. A point different from aforementioned Pattern 1 is that contents (Configuration) of communication settings respectively supporting Rev. 0 and Rev. A are determined before or at the time when communications with the base station 100A starts. Hereinafter, a description will be mainly given of the point different from aforementioned Pattern 1.

Each processing in steps S401 to 5421 shown in FIG. 11 corresponds to each processing in steps S201 to S221 shown in FIG. 9.

In step S401, the mobile terminal 300 begins data communications with the base station 100A in accordance with a main communication setting (Rev. A). Here, the base station 100A and the mobile terminal 300 determine content (configuration) of a communication setting supporting Rev. A as the “main communication setting.” Moreover, the base station 100A and the mobile terminal 300 determine content (configuration) of a communication setting supporting Rev. 0 as a “sub communication setting.”

In step S407, the mobile terminal 300 determines whether or not a request for a change to the sub communication setting (Rev. 0) is received.

In step S411, the mobile terminal 300 performs the change to the sub communication setting. In addition, in step S417, the mobile terminal 300 executes data communications with the base station 200A on the basis of the sub communication setting.

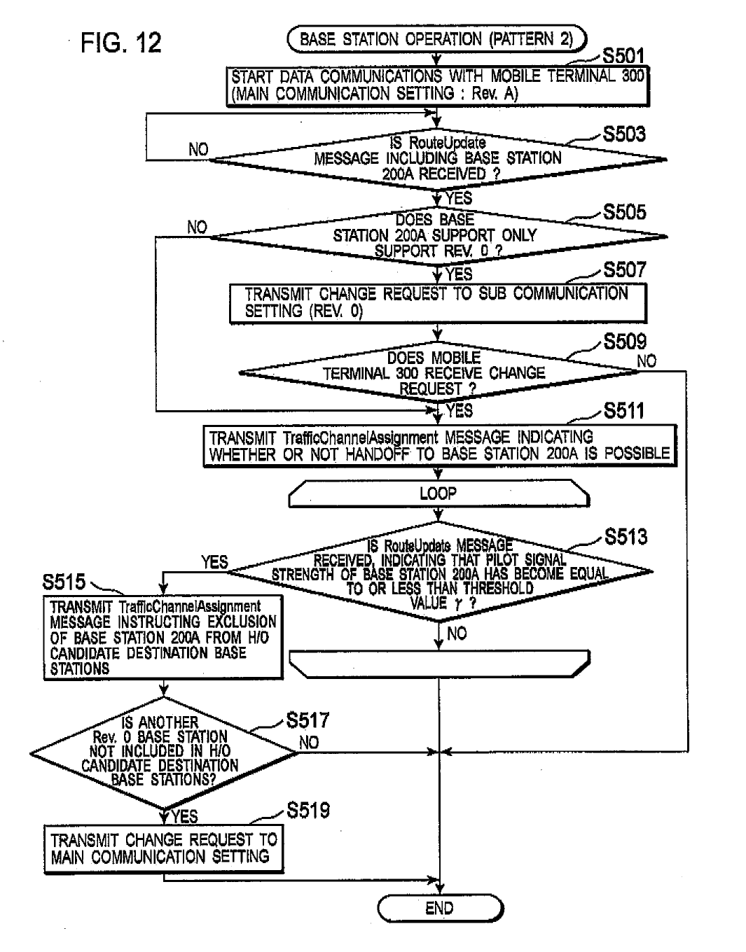

FIG. 12 is a detailed operation flow chart of the base station 100A according to Pattern 2. Each processing in steps S501 to 5519 shown in FIG. 12 corresponds to each processing in steps S301 to S319 shown in FIG. 10.

In step S501, the base station 100A starts data communications with the mobile terminal 300 in accordance with the main communication setting (Rev. A).

Here, the base station 100A and the mobile terminal 300 determine content (configuration) of a communication setting supporting Rev. A as a “main communication setting.” In addition, the base station 100A and the mobile terminal 300 determine content (configuration) of a communication setting supporting Rev. 0 as a “sub communication setting.”

In step S507, the base station 100A transmits a request for a change to the sub communication setting (Rev. 0) to the mobile terminal 300.

In step S519, the base station 100A transmits a request for a change to the main communication setting (Rev. A) to the mobile terminal 300.

### (4) Modification Example 1

FIGS. 9 and 10 described above show detailed operation flows in a case where the mobile terminal 300 supporting Rev. 0 and Rev. A is used. In the case of the mobile terminal 399, however, the operation substantially becomes one described below.

In the detailed operation flow of the mobile terminal 399, the processing in step S211 and the processing thereafter is omitted from the detailed flow of the mobile terminal 300 shown in FIG. 9. Specifically, since the mobile terminal 399 supports only Rev. A and handoff of the mobile terminal 399 to the base station 200A cannot be executed, the flow branches to “NO” in the processing of step S209.

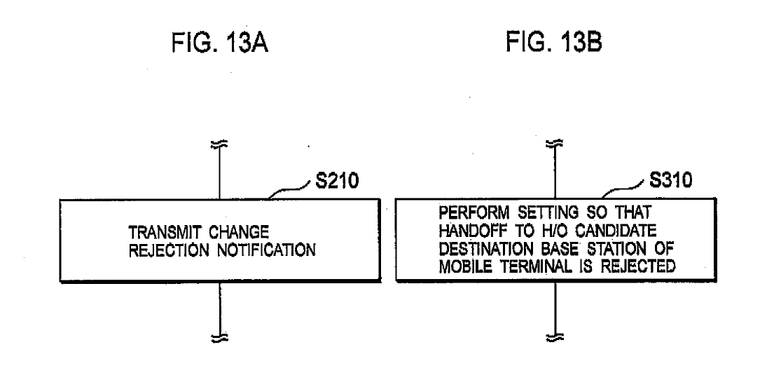

Thereafter, as shown in FIG. 13(a), in step S210 after the flow branches to “NO” in step S209, the mobile terminal 399 transmits, to the base station 100A, a change rejection notification (Attribute Update Reject message) for rejecting a change to communication settings supporting Rev. 0 and ends the processing.

Furthermore, the mobile terminal 399 may exclude the H/O destination candidate base station from handoff destination search targets.

In addition, in a detailed operational flow of the base station 100A, the processing in step S311 and the processing thereafter is omitted from the detailed operation flow of the base station 100A shown in FIG. 10. On the other hand, as shown in FIG. 13(b), in step S310 after the flow branches to “NO” in step S309, the base station 100A performs a setting for rejecting handoff of the mobile terminal 399 to the H/O destination candidate base station (the base station 200A), on the basis of the change rejection notification transmitted from the mobile terminal 399, and ends the processing.

### (5) Modification Example 2

In the aforementioned processing, handoff is initiated by the base station 100A and executed. In this modification example, however, handoff is initiated by the mobile terminal 300 and executed.

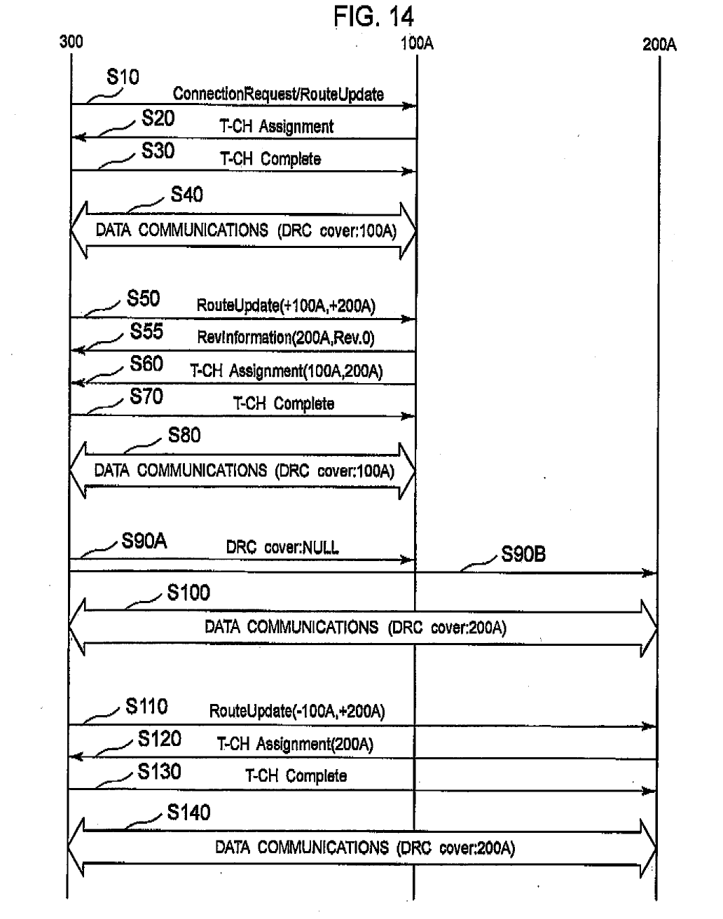

FIG. 14 is a schematic communication sequence diagram related to handoff of the mobile terminal 300 according to this modification example from the base station 100A to the base station 200A. A point different from the schematic communication sequence diagram shown in FIG. 8 is that processing of step S55 is added.

As shown in FIG. 14, in step S55, the base station 100A transmits, to the mobile terminal 300, a RevInformation message (communication capability information) indicating a communication capability of the handoff candidate base station (base station 200A).

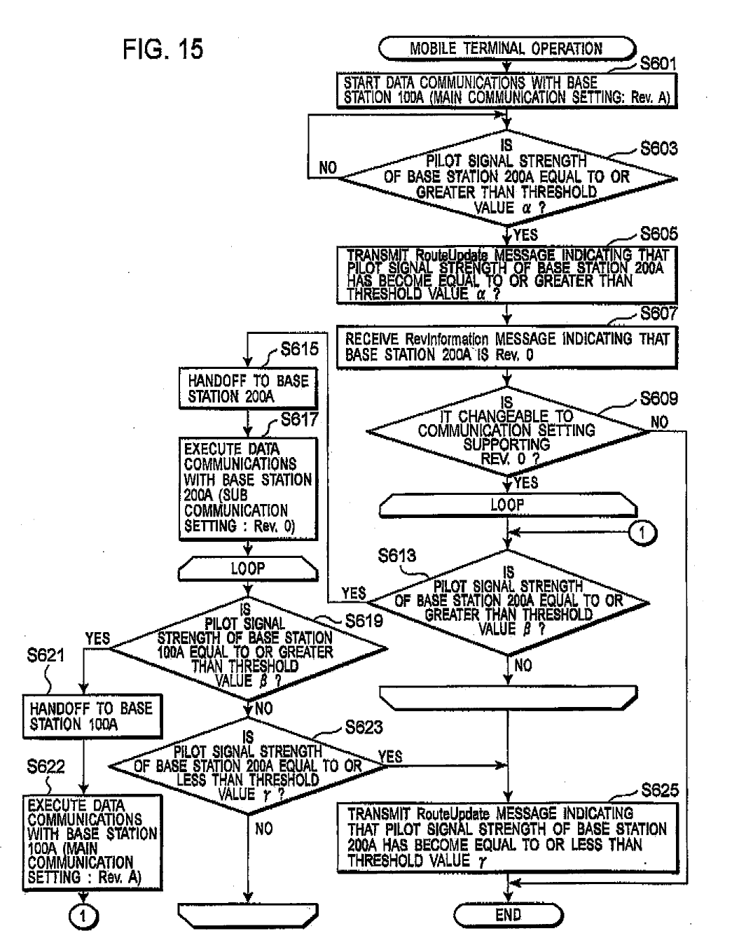

FIG. 15 is a detailed operation flow chart of the mobile terminal 300 according to this modification example. Each processing in steps S601 to S605 shown in FIG. 15 corresponds to each processing in steps S401 to S405 shown in FIG. 11.

In addition, a description of a detailed operation flow of the base station 100A according to this modification example is omitted since the flow is the same as the one shown in FIG. 12. In this modification example, however, a RevInformation message is transmitted from the base station 100A in step S607. Hereinafter, the processing shown in step S607 and the processing thereafter shown in FIG. 15 will be described.

In step S607, the mobile terminal 300 receives a RevInformation message indicating that the base station 200A supports only Rev. 0.

In a case where the pilot signal strength of the base station 200A is equal to or greater than the threshold value β (YES in step 5613), the mobile terminal 300 executes handoff to the base station 200A in step S615. Here, the mobile terminal 300 is previously notified through the RevInformation message that the base station 200A supports only Rev. 0.

In step 5617, the mobile terminal 300 then selects the sub communication setting (Rev. 0), and executes communications with the base station 200A in accordance with the selected sub communication setting.

In step S619, the mobile terminal 300 determines whether or not the pilot signal strength of the base station 100A is equal to or greater than the threshold value β.

In a case where the pilot signal strength of the base station 100A is equal to or greater than the threshold value β (YES in step S619), the mobile terminal 300 executes handoff to the base station 100A.

Furthermore, in step S622, the mobile terminal 300 selects the main communication setting (Rev. A), and executes communications with the base station 100A in accordance with the selected main communication setting.

In a case where the pilot signal strength of the base station 100A is not greater than the threshold value β (NO in step S619), the mobile terminal 300 determines whether or not the pilot signal strength of the base station 200A is not greater than the threshold value γ in step S623.

In a case where the pilot signal strength of the base station 200A is not greater than the threshold value γ (YES in step S623), the mobile terminal 300 transmits, to the base station 100A, a RouteUpdate message indicating that the pilot signal strength of the base station 200A has become not greater than the threshold value γ, in step S625.

In a case where the pilot signal strength of the base station 200A is greater than the threshold value γ (NO in step S623), the mobile terminal 300 repeats the processing from step

(Effects and Advantages)

According to the mobile communication system 10 according to the embodiment described above, on the basis of a RouteUpdate message (candidate base station notification) indicating that the pilot signal strength of the base station 200A or the base station 200B supporting only Rev. 0 has become equal to or greater than the threshold value α, a change to a communication setting supported by the base station currently in communications (handoff source base station) and by all of the handoff candidate base stations is performed. Specifically, in the present embodiment, a change to a communication setting supporting Rev. 0 is performed.

Specifically, the change to a communication setting supporting Rev. 0 is performed during the execution of data communication with the handoff source base station supporting Rev. A (the base station 100A, for example). Accordingly, it is possible to avoid a case where the data communications currently in execution is disconnected or the communication setting is re-set even if handoff is executed to a base station supporting only Rev. 0 after the aforementioned change is performed.

In other words, it is possible to resolve a problem that a duration of communication disconnection in handoff becomes longer. Note that the mobile terminal 300 can change content (configuration) of the communication setting in Rev. A at any time regardless of statuses of standby and execution of data communications. It is thereby made possible to avoid a case where the data communications currently in execution is disconnected or the communication setting is re-set.

According to the mobile communication system 10, contents of communication settings can be previously determined as the main communication setting to be the communication setting supporting Rev. A and the sub communication setting to be the communication setting supporting Rev. 0 at the time of starting data communications. Therefore, the concentration of processing load at the time of handoff can be avoided.

In addition, the mobile terminal 399 supporting only Rev. A is allowed to transmit a change rejection notification. Moreover, a base station supporting Rev. 0 and Rev. A (the base station 100A, for example) can perform a setting for rejecting handoff to a handoff candidate base station supporting only Rev. 0 (the base station 200A, for example).

It is thus possible to avoid that the mobile terminal 399 executes handoff to the handoff candidate base station even though the mobile terminal 399 cannot execute data communications with the handoff candidate base station supporting only Rev. 0.

Moreover, according to the mobile communication system 10, in a case where the handoff candidate base station (the base station 200A, for example) has become no longer included in handoff candidate base stations supporting only Rev. 0, the communication setting is promptly reset to the one supporting Rev. A. Therefore, the problem that a duration of communication disconnection in handoff becomes longer can be resolved and in the meantime, the probability that data communications are executed in accordance with Rev. A can be increased,

Furthermore, according to the mobile communication system 10, since handoff can be executed by the initiation of a mobile terminal, processing load fox the execution of handoff in a base station can be dispersed to the mobile terminal side, so that a larger number of handoffs can be promptly executed during the same period of time.

### Other Embodiments

As described above, although contents of the present invention are disclosed through an embodiment of the present invention, any description or drawing constituting a part of this disclosure should not be understood as limiting the present invention. Various alternative embodiments will be apparent from this disclosure to those skilled in the art.

For example, in the aforementioned embodiment of the present invention, a configuration in which information related to a handoff candidate base station is transmitted and received by use of a RouteUpdate message and a T-CH Assignment message is used. Types of messages used in the transmission and receipt of the information, however, do not have to be a RouteUpdate message or a T-CH Assignment message.

In addition, the functions of the aforementioned system controller 120 and the system controller 320 can be provided as a program executable by a communication device or a computer.

As described, the present invention also includes various embodiments and the like not described in this description as a matter of course. Accordingly, the technical scope of the present invention is only defined by the specific subject matters of the invention according to the scope of the invention as defined by the appended claims appropriate for this disclosure.

Note that the entire contents of Japanese Patent Application No. 2005-342175 (filed on Nov. 28, 2005) and Japanese Patent Application No. 2005-342179 (filed on Nov. 28, 2005) are incorporated in this description herein by reference.

### INDUSTRIAL APPLICABILITY

As has been described so far, since it is possible to shorten a duration of communication disconnection in handoff, a communication method, a mobile terminal and a base station according to the present invention are advantageous in radio communications such as mobile communications in a case where a mixture of devices having different communication capabilities related to data communications exist.

1. A communication method comprising the steps of:
transmitting a candidate base station notification notifying a handoff candidate base station having communication capability different from a base station currently executing communication, from a mobile terminal to a handoff source base station currently executing the communication with the mobile terminal; and
changing a handoff source communication setting set for the handoff source base station, to a communication setting corresponding to the communication capability supported by the handoff source base station and all of the handoff candidate base station, on the basis of the candidate base station notification.

2. The communication method according to claim 1, further comprising the step of determining plural pieces of communication setting configuration information indicating a communication setting corresponding to the communication capability, wherein
the step of changing changes to the communication setting configuration information supporting the handoff source base station and all of the handoff candidate base station when the candidate base station notification is received.

3. The communication method according to claim 2, wherein the communication setting configuration information is determined before or at the time when the mobile terminal begins communication with the handoff source base station.

4. The communication method according to any one of claims 1 to 3, further comprising the steps of:
rejecting, by the mobile terminal, a change to the communication setting; and
rejecting, by the mobile terminal, handoff to the handoff candidate base station when the mobile terminal rejects the change.

5. A mobile terminal comprising:
a candidate base station notification transmitter configured to transmit a candidate base station notification notifying a handoff candidate base station having communication capability different from a base station currently executing a communication, to a handoff source base station currently executing the communication;
a request receiver configured to receive a communication setting change request requesting a change to a communication setting corresponding to communication capability supported by the handoff source base station and all of the handoff candidate base station, from the handoff source base station; and
a communication setting execution unit configured to change a handoff source communication setting set for the handoff source base station, to a communication setting corresponding to the communication setting change request, on the basis of the communication setting change request received by the request receiver.

6. The mobile terminal according to claim 5, further comprising a communication setting storage unit configured to store plural pieces of communication setting configuration information indicating a communication setting corresponding to the communication capability, wherein
the communication setting execution unit changes to the communication setting configuration information supporting the handoff source base station and all of the handoff candidate base station, on the basis of the communication setting configuration information stored in the communication setting storage unit, when the candidate base station notification is received.

7. The mobile terminal according to any one of claims 5 to 6, further comprising a base station determination unit configured to determine whether or not a base station having the communication capability different from the handoff source base station is included in the handoff candidate base station, wherein
the communication setting execution unit reverts the communication setting corresponding to the handoff source base station and all of the handoff candidate base station back to the handoff source communication setting, when the base station determination unit determines that a base station having the communication capability different from the handoff source base station is not included in the handoff candidate base station.

8. A mobile terminal comprising:
a request receiver configured to receive a communication setting change request requesting a change to a communication setting corresponding to communication capability supported by a handoff candidate base station having the communication capability different from a base station currently executing communication, from a handoff source base station currently executing communication;
a handoff determination unit configured to determine whether a change to a communication setting corresponding to the communication setting change request is possible or impossible, on the basis of the communication setting change request received by the request receiver; and
a change rejection notification transmitter configured to transmit, to the handoff source base station, a change rejection notification indicating that a change to the communication setting corresponding to the communication setting change request is impossible, when the handoff determination unit determines that the change is impossible.

9. The mobile terminal according to claim 8, further comprising a handoff execution unit configured to exclude the handoff candidate base station from a search target of a handoff destination, when the handoff determination unit determines that the change is impossible.

10. A base station comprising:
a candidate base station notification receiver configured to receive a candidate base station notification notifying a handoff candidate base station having communication capability different from a base station currently executing communication, from a mobile terminal executing the communication; and
a communication setting execution unit configured to change a handoff source communication setting set for the mobile terminal, to a communication setting corresponding to the communication capability supported by a handoff source base station and all of the handoff candidate base station, on the basis of the candidate base station notification received by the candidate base station notification receiver.

11. The base station according to claim 10, further comprising a communication setting storage unit configured to store plural pieces of communication setting configuration information indicating a communication setting corresponding to the communication capability, wherein
the communication setting execution unit changes to the communication setting configuration information supporting the handoff source base station and all of the handoff candidate base station, on the basis of the communication setting configuration information stored in the communication setting storage unit, when the candidate base station notification is received.

12. The base station according to any one of claims 10 and 11, further comprising a base station determination unit configured to determine whether or not a base station having different communication capability is included in the handoff candidate base station, wherein
the communication setting execution unit reverts the communication setting corresponding to the handoff source base station and all of the handoff candidate base station back to the handoff source communication setting, when the base station determination unit determines that a base station having different communication capability is not included in the handoff candidate base station.

13. The base station according to claim 10 or 11, further comprising:
a change rejection notification receiver configured to receive a change rejection notification indicating that a change to a communication setting corresponding to the communication capability supported by the handoff candidate base station is impossible, from the mobile terminal; and
a handoff rejection unit configured to reject handoff of the mobile terminal to the handoff candidate base station, when the change rejection notification receiver receives the change rejection notification.

14. A communication method comprising the steps of;
transmitting a candidate base station notification notifying a handoff candidate base station having communication capability different from a base station currently executing communication, from a mobile terminal;
transmitting communication capability information indicating the communication capability of the handoff candidate base station on the basis of the received candidate base station notification, from a handoff source base station currently executing the communication with the mobile terminal; and
changing, by the mobile terminal, a handoff source communication setting set for the handoff source base station, to a communication setting corresponding to the communication capability supported by the handoff source base station and all of the handoff candidate base station, on the basis of the received communication capability information.

15. The communication method according to claim 14, further comprising the step of determining plural pieces of communication setting configuration information indicating a communication setting corresponding to the communication capability, wherein
in the step of changing changes to the communication setting configuration information corresponding to the handoff candidate base station, on the basis of the communication capability information, when the mobile terminal executes handoff to the handoff candidate base station.

16. A mobile terminal comprising:
a candidate base station notification transmitter configured to transmit a candidate base station notification notifying a handoff candidate base station having communication capability different from a base station currently executing communication, to a handoff source base station currently executing the communication;
an information receiver configured to receive communication capability information indicating communication capability of the handoff candidate base station, from the handoff source base station; and
a communication setting execution unit configured to change a handoff source communication setting set for the handoff source base station, to the communication setting corresponding to the handoff source base station and all of the handoff candidate base station, on the basis of the communication capability information received by the information receiver.

17. The mobile terminal according to claim 16, further comprising a communication setting storage unit configured to store plural pieces of communication setting configuration information indicating a communication setting corresponding to the communication capability, wherein
the communication setting execution unit selects the communication setting configuration information corresponding to the handoff candidate base station from the communication setting storage unit on the basis of the communication capability information, and changes to the selected communication setting configuration information.

18. A base station comprising:
a candidate base station notification receiver configured to receive a candidate base station notification notifying a handoff candidate base station having communication capability different from a base station currently executing communication, from a mobile terminal executing the communication; and
an information transmitter configured to transmit communication capability information indicating communication capability of the handoff candidate base station to the mobile terminal, on the basis of the candidate base station notification received by the candidate base station notification receiver.
